(19) United States
(12) Patent Application Publication
(10) Pub. No.: US 2011/0145013 A1
(43) Pub. Date: Jun. 16, 2011

(54) Integrated Electronic Health Record (EHR) System with Transcription, Speech Recognition and Automated Data Extraction

(76) Inventor: Mark McLaughlin, Scottsdale, AZ (US)

(21) Appl. No.: 12/959,304

(22) Filed: Dec. 2, 2010

Related U.S. Application Data
(60) Provisional application No. 61/265,858, filed on Dec. 2, 2009.

(51) Int. Cl. G06Q 50/00

(52) U.S. Cl. 705/3

(57) ABSTRACT

An integrated health record system comprises a platform including a processor coupled to a medical application. The system includes at least one input device coupled to the processor. The input device receives patient information of a patient via an electronic form and receives vital signs of the patient. The medical application integrates the patient information and the vital signs into an electronic health record (EHR) that corresponds to the patient. The medical application receives a sound file that includes information resulting from an examination of the patient, and translates the sound file into a document that comprises a clinical document architecture (CDA). The medical application parses the document and identifies a plurality of data components based on a correspondence to a plurality of data fields of the HER. The medical application populates each of the plurality of data fields with each of the data components.

### RELATED APPLICATION

This application claims the benefit of U.S. Patent Application No. 61/265,858, filed Dec. 2, 2009.

### TECHNICAL FIELD

The embodiments herein relate generally to an electronic healthcare record (EHR) and, more specifically, to systems and methods in which patient health information is processed into the EHR during a patient examination.

### BACKGROUND

In a conventional health care provider setting, when the provider is using an electronic health record (EHR), the provider is forced to alter their workflow in order to interact with the computer. This produces less provider/patient interaction and more provider/computer interaction. Providers prefer to remain interactive with the patients rather than the computer.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a block diagram of the MxChart integrated electronic health record (EHR) system, under an embodiment.

FIG. 2 is a block diagram of the MxChart platform, under an embodiment.

FIG. 3 is a flow diagram for a patient encounter using the MxChart, under an embodiment.

FIG. 4 is an example Editor Screen of MxChart, under an embodiment.

FIG. 5 is an example of the Editor Screen of the Instant Note Kit, under an embodiment.

FIG. 6 is an example real text format document template, under an embodiment.

FIG. 7 is an example of a rendered real text format document, under an embodiment.

### DETAILED DESCRIPTION

Integrated electronic health record (EHR) systems and methods, also referred to herein as MxChart, are described herein. It is to be understood that the detailed description are examples provided herein are examples only and are not to restrict the systems and methods described herein to only the systems and methods described herein. Although the illustrated embodiments relate to a medical environment, the systems and methods described herein are applicable to other healthcare environments as well, such as dental, for example. The following is intended to illustrate example ways to make and use what is regarded as the invention, the scope of which is to be defined solely by the appended claims.

MxChart is an integrated web-based or locally-situated electronic health record (EHR) system that accesses a web server configured in accordance with HITECH regulations. In addition to the functionality of the EHR, MxChart integrates transcription and speech recognition components and functionality to provide a unique and efficient workflow for health care providers (referred to herein as Providers).

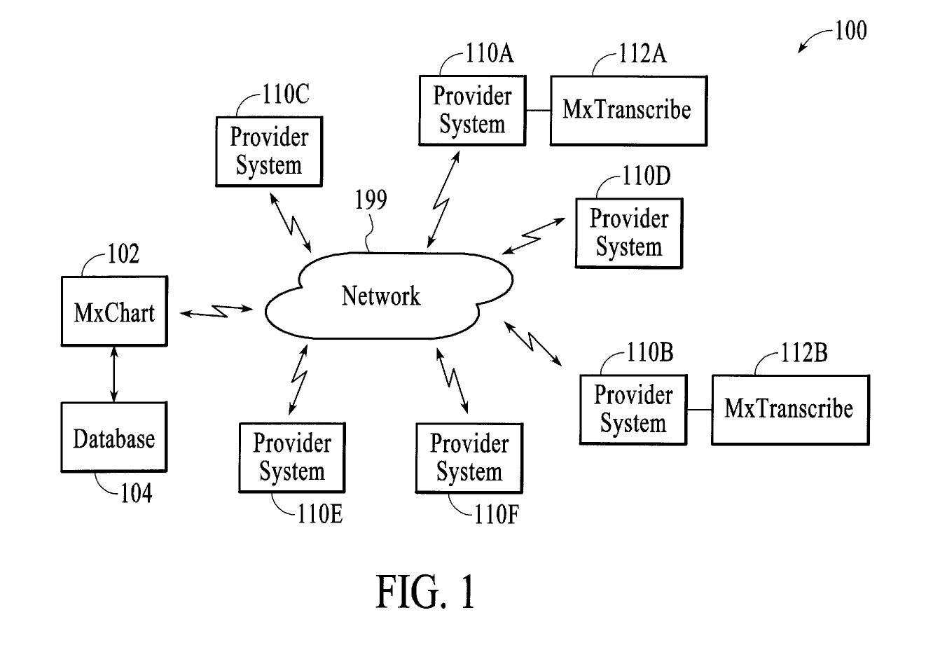

FIG. 1 is a block diagram of the MxChart integrated electronic health record (EHR) system 100, under an embodiment. The system 100 comprises the MxChart platform 102 coupled or connected to a network 199. The MxChart platform 102 can include and/or couple to a database 104 that is generally located remotely from the Provider's clinic, office, hospital or other site. The database 104 can store in a secure manner any information provided to the MxChart platform 102; examples of information of the database 104 include but are not limited to patient healthcare information, such as medical diagnoses, treatments, caregiver comments and impressions, medications, test results, and diagnostic data to name a few.

The system 100 further comprises provider systems 110A-F (collectively referred to herein as “provider systems 110”) at the facilities of one or more Providers or other place at which the patient receives services. The provider systems 110 comprise computers or processor-based systems that can communicate with and access the MxChart platform 102 and database 104 via the network 199. The provider system 110A of an embodiment can include and/or be coupled to the MxTranscribe or Instant Note Kit component 112A of the MxChart system 100, as described in detail below. Alternatively, the provider system uses the MxNotes component of the MxChart platform 102, as described in detail below. The provider system 110 can have any suitable structure and can be a stand-alone device or integrated with another device, such as a computer system, a mobile computing device, or a personal computing device. As such, the provider system 110 can comprise personal computers through which medical information can be accessed via the MxChart 102. For example, the provider system 110 can be a conventional personal computer having a keyboard, display, input/output (I/O) device, memory and other hardware and software elements generally included in personal computers. In a physician's office or hospital, it can be the computer system that is otherwise used apart from the embodiments herein for maintaining records, calendaring appointments, accounting, and other administrative tasks, or it can be a separate computer. Additionally, the provider system 110 has network communication hardware and software that enables communication with other computers and/or servers.

Communication paths couple the system components and include any medium for communicating or transferring files among the components. The communication paths referred to herein as the “network” 110 include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Although not shown for purposes of clarity, the provider system 110 can access the MxChart 102 via the World Wide Web (“Web”) using conventional Web browser software, for example. As known in the art, a Web browser is a client program that effects the retrieval of hypertext documents (web pages) from suitably configured Web servers. Web pages can also be forms that a user of the browser can fill in and transmit to a server. The MxChart 102 of an embodiment includes suitable server software to provide the information requested by Providers 110 in Web page format.

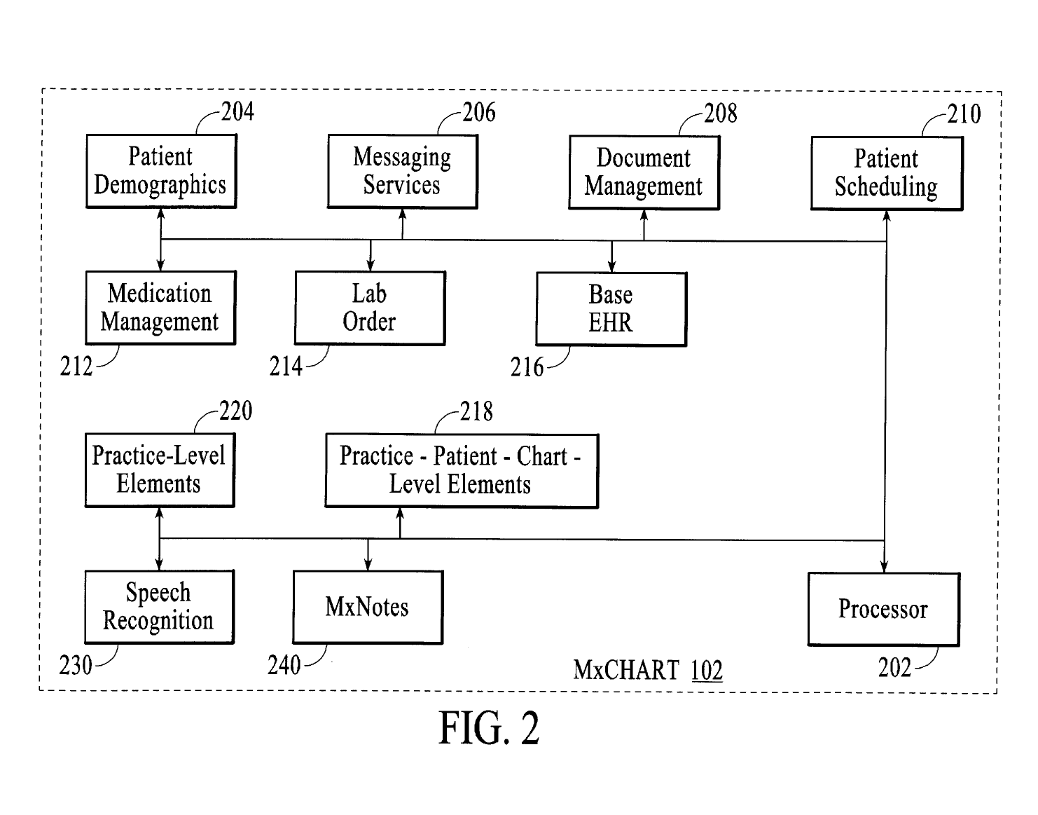

FIG. 2 is a block diagram of the MxChart platform 102, under an embodiment. The MxChart 102 of an embodiment comprises a processor 202 coupled or connected to components or modules 204-240. The MxChart components or modules 204-240 provide the functions described in detail herein. For example, the MxChart 102 includes one or more of the following components, but is not limited to one or to any combination of these components: patient demographics component 204; messaging services component 206; document management component 208 (e.g., scanning, indexing, auto-uploading of documents, editing, OCR, etc.); patient scheduling component 210. The MxChart 102 also includes one or more of the following components, but is not limited to one or to any combination of these components: medication management component 212; lab order component 214; base EHR component 216; general practice-patient-chart-level component 218 (other sub-specialties will vary and are also included); general practice-level component 220. As described in detail below, the MxChart also includes a speech recognition component 230, Instant Note Kit component (not shown), and MxNotes 240.

The medication management component 212 of an embodiment includes one or more of the following functions, but is not so limited: interface to Surescripts or other third parties connected to similar prescribing platforms; E-prescribing; E-faxing; printing (security paper); refill existing medication; show medication history including active and inactive drugs; allow capture of over-the-counter medications; produce DUR warnings for drug-drug, drug-allergy, drug-disease state; provider override with audit trail on warnings.

The lab orders component 214 of an embodiment includes one or more of the following functions, but is not so limited: interface to LabSoft or other third parties connected to similar lab interface engines; produce lab orders; receive lab results; allow for facility/Provider notification of receipt of lab results; allow for sign off of lab results; patient notification.

The base EHR component 216 of an embodiment includes one or more of the following functions, but is not so limited: enables the building, addition or removal of new screens from an existing screens list. Screens, whether added or removed, interact with the access levels (see access levels document). Information on some screens is accessible from other screens. If adding screens, the screen will show up in the tabbed section of the dynamic portion of the patient chart. If removing screens the screens are removed from the dynamic portion of the patient chart. If adding new screens, the base EHR enables defining and positioning of new data elements in provider preference order. The addition or removal of screens and data elements is provider specific.

The general practice-patient-chart-level component 218 of an embodiment includes one or more of the following functions, but is not so limited: a Face Sheet that includes configurable sections of data that summarize all tabbed sections (e.g., History Present Illness, Physical exam, Review of systems, Vitals, etc.), where sections can be added, removed or relocated in provider order preference; patient demographics (listed above); patient vitals (e.g., temperature, blood pressure, pulse, respiration, height, weight, body mass index (BMI), and body fat etc.), including graphing capabilities for tracking against history, and pediatric growth chart comparisons; chief complaint/reason for visit (problem list); medical history (e.g., past medical history, past surgical history, social history, family history, mental health history, preventative history, immunization history, etc.); history of present illness; physical exam; review of systems (incorporate body diagrams with point and click areas of focus, etc.); labs (listed above); medications (listed above); allergies; diagnosis and procedures; documents patient specific (listed above); encounter summary (automatically created based on selections from the encounter); plan (e.g., provider's course of treatment for this patient, etc.); Superbill creation/passing of charges to PMS.

The general practice-level component 220 of an embodiment includes one or more of the following functions, but is not so limited: messaging with patient level and practice/Provider level alerts (listed above); patient education, diet, etc.; practice standard forms, preformatted letters, consent forms, etc.; documents and scanning (listed above); fax; printing; administration (e.g., access level configuration; audit trail configuration; login creation; password configuration and stringency settings; password reset rules (timeouts, failed attempts, etc.); backup configuration (if local); screens and data element configuration; configuration of time for engagement of hybrid solution; security; etc.); reporting (e.g., practice financial reports; clinical workflow reports; pay for performance reporting; e-Prescribing reporting (tracking potential abuse by Provider and patient as well as percentage of prescriptions sent by e-prescribing).

The MxChart 102 of an embodiment integrates with and/or couples to other systems in the health care provider environment. For example, the MxChart 102 integrates with one or more of third-party practice management systems, patient portals, Personal Health Record systems, other EHR systems, medical devices (e.g., Welch Allyn for automatically recording vitals), and/or MxTranscribe 4.0 or later MxNotes2.0 or later, and the Instant Note Kit.

MxTranscribe is desk-top software that provides for the voice capture of clinical content from Provider/patient encounters, transcription or translation of the captured voice file into a transcribed document, and the identification of key pieces of information that are able to be extracted and imported into MxChart 102. MxNotes 240 is the web-based equivalent to MxTranscribe.

The Instant Note Kit is an application or software that aids physicians in the interactive process of documenting visits with their patients without necessarily having to send that documentation through to a transcriptionist although that option is not excluded. Descriptive narratives of a patient visit are referred to in medical practices as “notes” and thus the name “Instant Note Kit”—a collection of tools that makes the creation of these notes quick and simple.

The Instant Note Kit can be used during a patient encounter, and runs on a tablet, laptop, desktop or Netbook PC and does not require a network or internet connection. The Instant Note Kit includes dictation/transcription functionality. The Instant Note Kit allows detail of the patient encounter to be included in the note, and also allows for portions of the note to be dictated and/or typed. The Instant Note Kit includes pre-formatted boilerplates created for specific users and work types, and allows users to easily customize these tools. The Instant Note Kit includes macros and “normals” in a customizable implementation to improve productivity.

The Instant Note Kit includes a narrative component and, additionally, template-style functionality in notes such that point and click operation can be used to facilitate note creation. Therefore, the Instant Note Kit does not require the user to do significant work to get to the “right spot” in the application because, as a stand-alone application, the user is already at the right spot in the Instant Note Kit when they log in.

The Instant Note Kit includes a speech recognition application that allows the user to utilize speech recognition where it is needed and then to use the faster techniques (e.g., macros, normals and templates) where possible.

In operation, the Instant Note Kit provides a login prompt to a user, and at the login prompt the user can login using either MxTranscribe, MxNotes or MxChart user credentials. A user can also choose to work offline and bypass the login. If the user chooses to work offline, they are able to create notes but are not able to upload those notes to MxSecure for inclusion in MxTranscribe, MxNotes or MxChart. When the user has worked offline, the user is prompted during the next subsequent login to upload any notes that were created during the offline sessions.

MxTranscribe, MxNotes, and Instant Note Kit of an embodiment enable recording of transcription information. Consequently, the Provider, after a patient encounter, records information about the patient encounter and may pass the voice file on for transcribing.

MxTranscribe, MxNotes, and Instant Note Kit of an embodiment includes numerous methods by which voice files are transcribed, including but not limited to manual transcription, back-end speech recognition, and front-end speech recognition. Manual transcription comprises MxSecure personnel listening to captured voice files and entering the information into the appropriate document type (template). Back-end speech recognition comprises processing a captured voice file using a speech recognition engine, where the speech recognition engine creates the document based on the document type. Front-end speech recognition operates such that, once the provider is finished with the dictation, the front-end speech recognition immediately produces a transcribed document based on the preferred document type.

The Instant Note Kit of an embodiment provides editing functionality. The editing enables editing of a transcribed voice file.

The Instant Note Kit of an embodiment enables the provider to perform quality assurance (QA) functionality. Therefore, after editing is complete, the provider ensures the document is accurate and is prepared to be finalized on the Provider system.

The Instant Note Kit of an embodiment enables provision of a transcribed document. Following quality assurance of a transcribed document, the transcribed document is prepared to be finalized by the Provider. The transcribed document can be in any format (e.g., Microsoft Word, .RTF, etc.) that can be stored electronically on the Providers system. MxTranscribe/MxNotes of an embodiment provides editing functionality. The editing enables editing of a transcribed voice file.

MxTranscribe/MxNotes of an embodiment include quality assurance (QA) functionality. Therefore, after editing is complete, quality assurance ensures the document is accurate and is prepared to return to the Provider system.

MxTranscribe/MxNotes of an embodiment enables provision of a transcribed document. Following quality assurance of a transcribed document, the transcribed document is returned to the Provider. The transcribed document can be in any format (e.g., Microsoft Word, .RTF, etc.) that can be stored electronically on the Providers system.

The MxChart 102 uses the components described above to generate or create a Health Level 7 (HL7) Clinical Document Architecture (CDA) document. The HL7 CDA document is a document comprising a tagged format that is computer readable. The Appendix below includes an example of the HL7 CDA document under an embodiment. MxTranscribe, MxNotes, and Instant Note Kit produce the CDA document which can then be absorbed by MxChart. MxChart places specifically tagged information into the EHR for the purpose of notes capture, data comparison and analysis, and automatic diagnosis and procedure identification.

The systems, components and methods described herein include and/or run under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server.

The portable computer can be any of a number and/or combination of devices selected from among personal computers, cellular telephones, personal digital assistants, portable computing devices, and portable communication devices, but is not so limited. The processing system can include components within a larger computer system. The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components of a host system, and/or provided by some combination of algorithms. The methods described herein can be implemented in one or more of software algorithm(s), programs, firmware, hardware, components, circuitry, in any combination.

System components embodying the systems and methods described herein can be located together or in separate locations. Consequently, system components embodying the systems and methods described herein can be components of a single system, multiple systems, and/or geographically separate systems. These components can also be subcomponents or subsystems of a single system, multiple systems, and/or geographically separate systems. These components can be coupled to one or more other components of a host system or a system coupled to the host system.

As described above, in a Provider setting today, when the Provider is using an electronic health record (EHR), the Provider is forced to alter their workflow in order to interact with the computer. This produces less Provider/patient interaction and more Provider/computer interaction. Providers prefer to remain interactive with the patients rather than the computer. However, the MxChart 102 integrated with MxTranscribe, MxNotes, or Instant Note Kit enables providers to interact with the patient during the encounter, dictate encounter information post-encounter, and automatically receive transcribed information within the EHR, thereby reducing or eliminating the need for the Provider to type all the transcribed information into the EHR. Thus, the MxChart 102 integrated with MxTranscribe, MxNotes, or Instant Note Kit simplifies the physicians existing workflow and enables physicians to better serve patients while receiving the information they need to electronically manage their practice.

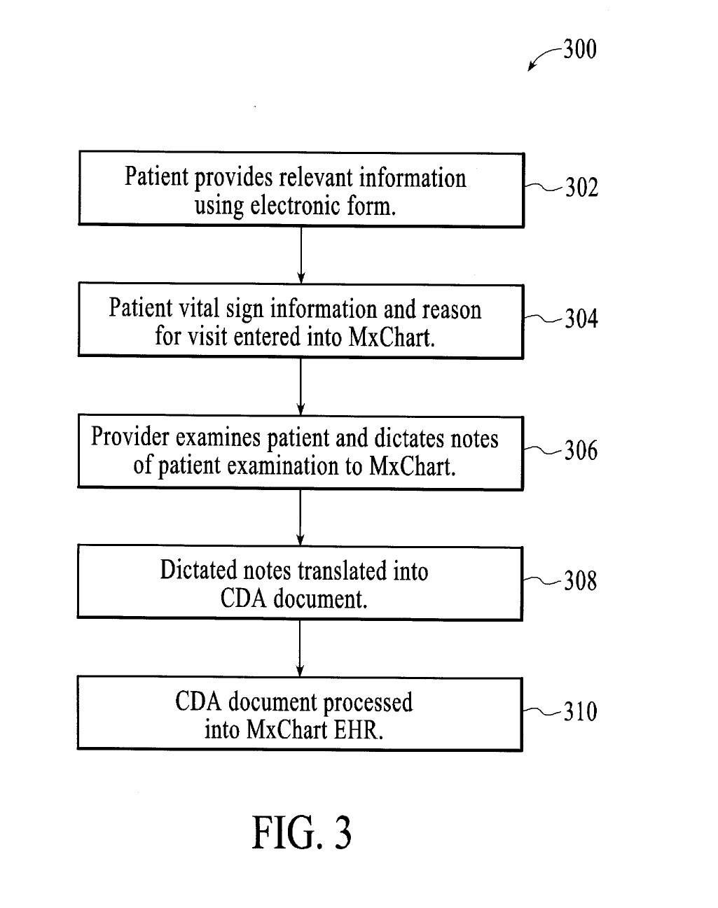

FIG. 3 is a general flow diagram for a patient encounter 300 using the MxChart, under an embodiment. The encounter begins when the patient arrives at the provider's office and provides relevant information using an electronic medical information form 302. The form can capture any information relevant to the visit such as past medical history as well as reasons for the current visit. This information is imported into MxChart. The patient's vital signs are obtained and this information is directly recorded into MxChart by the Provider personnel along with any clarifying information related to the chief complaint or reason for visit 304. The Provider conducts the examination and dictates progress notes, diagnosis, procedures, assessment, and the plan for the patient 306. The dictated notes of the examination are translated into a CDA document 308. The CDA document is then processed into the EHR 310 where the CDA document is archived and stored for future reference. The detailed example of the patient encounter that follows includes a provider workflow with transcription, speech recognition, and automated discrete data extraction into the MxChart EHR.

More specifically, a patent encounter begins when the patient arrives at the provider's office and registers at the front desk. If the patient encounter is a first encounter for the patient in the practice they are asked to electronically fill out medical history information. The specialized application is configured for ease-of-use for the patient and captures information such as past medical history, past surgical history, social history, family history, mental health history, preventative history, and immunization history, to name a few. The gathering of this information electronically upon initiation of an encounter eliminates the need for the Provider to capture the information at the time of encounter. This information will be directly imported into MxChart. In addition to the first-time collection of medical history, the patient is asked to fill out the electronic form identifying their chief complaint or reason for visit, and this information is directly imported into MxChart.

The patient is shown into an exam room where Provider or other personnel record the patient's vital signs. Vital signs include but are not limited to temperature, weight, height, blood pressure, respiration, body mass index (calculated) and body fat (calculated), to name a few. This information is directly recorded into MxChart by the Provider or other personnel. The Provider or other personnel then ask any clarifying questions related to the chief complaint or reason for visit and record any additional information directly into MxChart.

The Provider conducts the examination and continues to assess the patient. At this point the Provider is primarily interacting with the patient and not with the computer. The Provider only uses the computer to access information recorded about vitals, chief complaint or reason for visit, past history, labs, medications. This is in contrast to conventional EHR systems, which force the provider to interact with the computer rather than the patient.

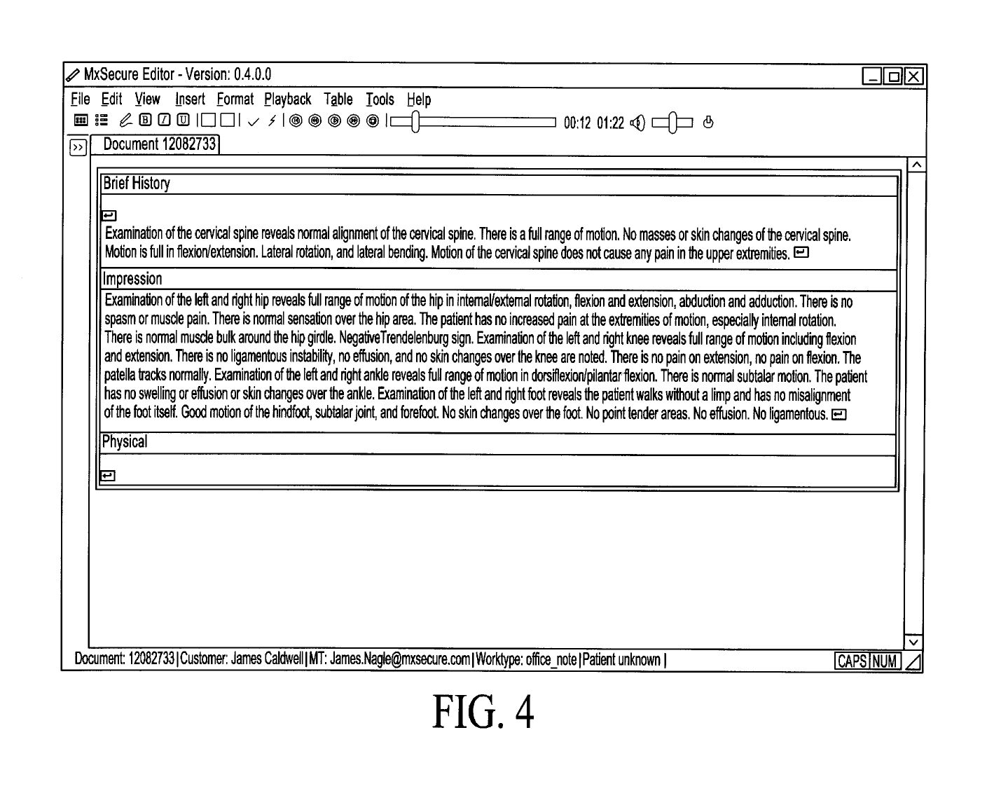

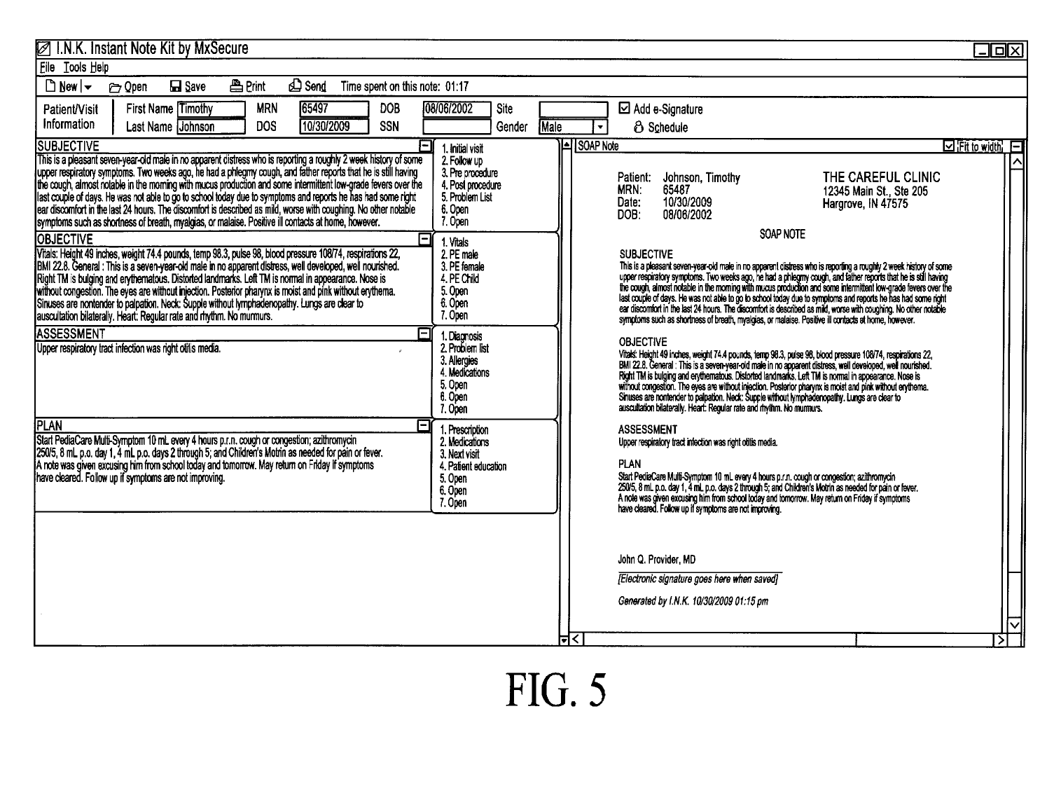

At the point the examination comes to conclusion the Provider dictates progress notes, diagnosis, procedures, assessment, and the plan for the patient, and this dictation produces or generates a .wav file (sound file). The .wav file is imported into the speech recognition translation software of the MxTranscribe, MxNotes, or Instant Note Kit. The software translates the .wav file into a CDA document, as described above and in the Appendix. The CDA document is displayed in a human readable format by an Editor of the MxTranscribe, MxNotes, or Instant Note Kit and is subsequently imported into MxChart. FIG. 4 shows an example Editor Screen of MxTranscribe, under an embodiment. FIG. 5 shows an example of the Editor Screen of the Instant Note Kit, under an embodiment.

With reference to the Editor Screen of the Instant Note Kit (FIG. 5), a user creates a note using the Instant Note Kit by selecting the “New” button on the toolbar and selects the type of note that they wish to create. A series of sections outlining the note will appear. If the user is actively sending patient schedules to MxSecure, they are allowed to click the “Schedule” button and select a patient; if not, then they must enter the information by typing in the fields provided.

Each section of the note may have links to macros, normals and templates provided specifically for that section. These are listed as items 1-7 in the box just to the right of the section. When appropriate, the user either clicks on the item or (if the cursor is inside the section) presses ALT+# (where # is the number 1-7 of that item). This will either insert the text, or bring up a pop-up that requires some interaction and then inserts the text. When narrative details are needed, the user either types or uses the speech recognition to create the details. Upon completion, the user scans the preview pane to ensure that the document has the appearance and content intend, and selects the “Save” button.

The provider has the option to either edit the document themselves or send it to a transcriptionist for editing. Editing includes ensuring that the dictation is accurately reflected in the translated text and that the sections within the editor accurately reflect the information that is contained within the section. If the provider chooses to use the Editor to edit the document themselves, then once completed with the editing and formatting to ensure everything is in the appropriate section the provider can approve the document. The approved document is saved and locked such that no further changes are allowed.

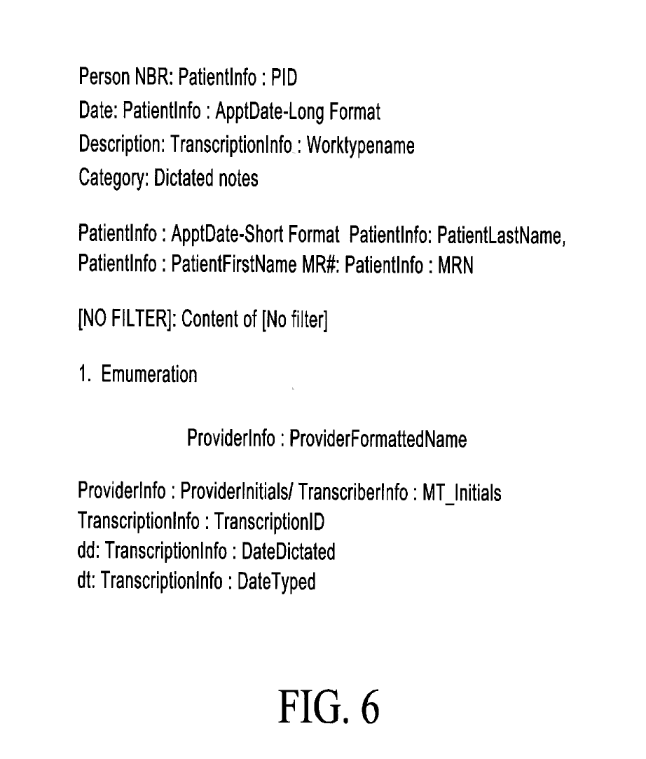

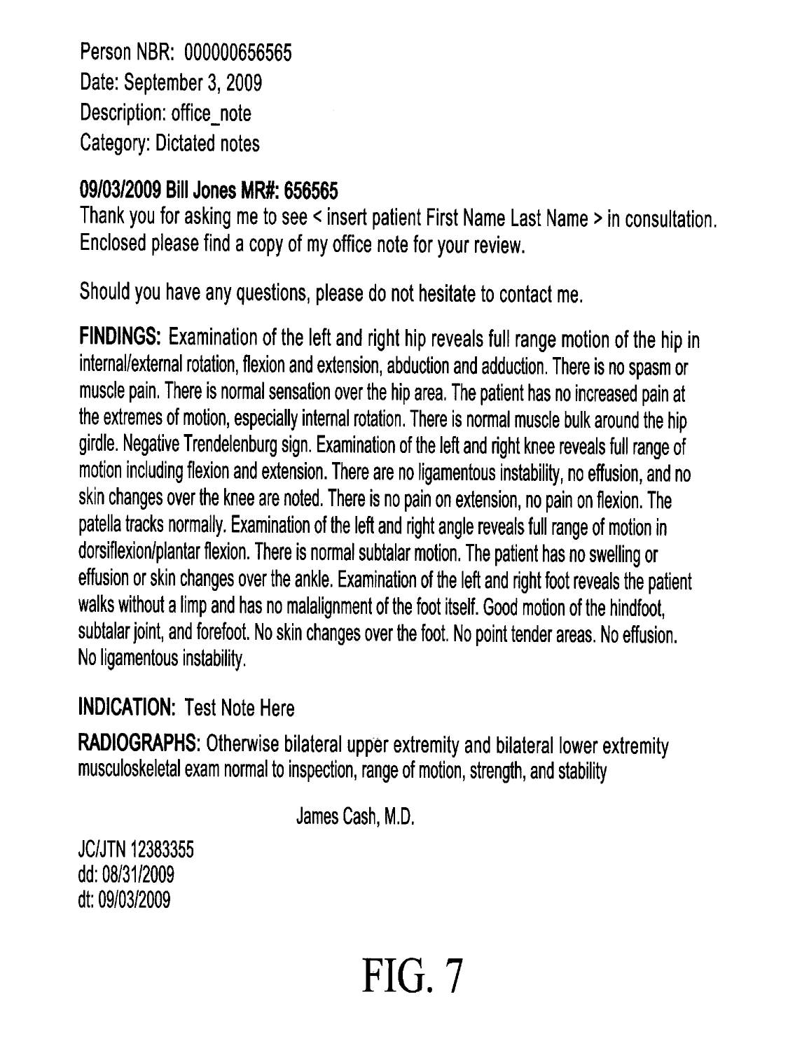

At this point the CDA document is ready to be processed into the EHR. The CDA document is programmatically parsed for discrete pieces of information that will populate specific sections of the EHR. Depending on the type of transcribed document, different sections of the EHR may be populated. For example, office visit notes can include information about the assessment and plan as well as diagnosis and/or procedures performed. That discrete information is extracted into the appropriate section of the EHR automatically without manual intervention. The CDA document is merged with a document template effectively publishing it into a document. As one example, the CDA document is merged with a real text format document template effectively publishing it into a real text format document. FIG. 6 shows an example real text format document template, under an embodiment. FIG. 7 shows an example of a rendered real text format document, under an embodiment. The published document is electronically filed in its entirety in the MxChart document section. The CDA document is archived and stored for future reference.

If, instead of editing the document themselves, the Provider sends the document to the transcriptionist, the transcriptionist edits the CDA using the Editor and transfers the document back to the Provider. Once the Provider receives the updated CDA document from the transcriptionist the Provider reviews, edits, and approves the document. The approved document is saved and locked such that no further changes are allowed.

At this point the CDA document is ready to be processed into the EHR. The CDA document is programmatically parsed for discrete pieces of information that will populate specific sections of the EHR. Depending on the type of transcribed document, different sections of the EHR may be populated. For example, office visit notes can include information about the assessment and plan as well as diagnosis and/or procedures performed. That discrete information is extracted into the appropriate section of the EHR automatically without manual intervention. The CDA document is merged with a document template effectively publishing it into a document. As one example, the CDA document is merged with a real text format document template effectively publishing it into a real text format document. As described above, FIG. 6 is an example real text format document template, and FIG. 7 is an example of a rendered real text format document, under an embodiment. The published document is electronically filed in its entirety in the MxChart document section. The CDA document is archived and stored for future reference.

MxChart and MxTranscribe employ a logic version control (LVC) technique that combines user authentication and program updates in a unique fashion which guarantees that users of the applications have the proper version of the application without the need for the user have administrative rights or the need for the user to take any action to obtain the updated software.

The LVC of an embodiment includes deploying applications for the Windows Operating systems (XP, Vista and Windows 7) in such a way that user authentication is combined with the deployment of updates to the application. This system also gives the vendor the ability to deploy distinct versions to specific users if desired. Every user is assigned a required version number and the system ensures that version is delivered to them in conjunction with them logging in to the application.

The LVC of an embodiment is accomplished through the use of two EXEs. The first EXE, referred to as the LVC application, is deployed using a traditional windows installer and it is installed wherever the user chooses, most typically under “Program Files” folder. The first EXE handles the user authentication and the version checking and updating (when needed). The second EXE (collection of EXEs, DLLs and support files) comprises the “Main Application”. These files are installed in the user folder in windows under “Application Data”.

In operation, the LVC EXE actions include, but are not limited to, those is the description that follows. A login screen is displayed. The existing build number of the main application is captured. A user enters credentials, and the credentials and current build number are sent to the server. The server checks the user credentials and, if valid, returns the required build number for that user. If the required build number does not match the existing build number, then the server returns a URL pointing to a zip file that contains the required version. If a URL was sent back, LVC downloads the zip file and unzips it into the Application Data folder. During the login process on the server, a unique token is created and stored in the user record in the database. The LVC then calls the “main” application with that token. This token is different every time and it cannot be hacked, and this prevents any users from trying to access the main application without going through LVC.

The user database stores a “required” build number for each user in the system. When new builds of the main application are made, a file called “version.dat” is created and placed in the zip file along with all other files for that version. The LVC application uses the version.dat file when determining the current installed version.

Updates are downloaded as zip files and unzipped by the LVC application.

If for any reason the download fails, the LVC application will try again. If it fails again, the login will fail and the user must login again. If the application is unable to overwrite the existing version of the main application, the user is prompted to restart their computer (to free any locks that may be on the files). After the restart, and upon user login, the update will complete.

Embodiments described herein include an integrated health record system comprising a platform including a processor coupled to a medical application. The system of an embodiment includes at least one input device coupled to the processor. The input device of an embodiment receives patient information of a patient via an electronic form and receives vital signs of the patient. The medical application of an embodiment integrates the patient information and the vital signs into an electronic health record (EHR) that corresponds to the patient. The medical application of an embodiment receives a sound file that includes information resulting from an examination of the patient, and translates the sound file into a document that comprises a clinical document architecture (CDA). The medical application of an embodiment parses the document and identifies a plurality of data components based on a correspondence to a plurality of data fields of the HER. The medical application of an embodiment populates each of the plurality of data fields with each of the data components.

Embodiments described herein include a system comprising: a platform comprising a processor coupled to a medical application; at least one input device coupled to the processor, wherein the at least one input device receives patient information of a patient via an electronic form and receives vital signs of the patient; wherein the medical application integrates the patient information and the vital signs into an electronic health record (EHR) that corresponds to the patient; wherein the medical application receives a sound file that includes information resulting from an examination of the patient, and translates the sound file into a document that comprises a clinical document architecture (CDA); wherein the medical application parses the document and identifies a plurality of data components based on a correspondence to a plurality of data fields of the EHR; and wherein the medical application populates each of the plurality of data fields with each of the data components.

Embodiments described herein include a method running on a processor of a platform. The method of an embodiment comprises receiving patient information from a patient via an electronic form. The method of an embodiment comprises receiving vital signs of the patient. The method of an embodiment comprises integrating the patient information and the vital signs into an electronic health record (EHR) that corresponds to the patient. The method of an embodiment comprises receiving a sound file that includes information resulting from an examination of the patient, and translating the sound file into a document that comprises a clinical document architecture (CDA). The method of an embodiment comprises parsing the document and identifying a plurality of data components based on a correspondence to a plurality of data fields of the EHR. The method of an embodiment comprises populating each of the plurality of data fields with each of the data components.

Embodiments described herein include a method running on a processor of a platform, the method comprising: receiving patient information from a patient via an electronic form; receiving vital signs of the patient; integrating the patient information and the vital signs into an electronic health record (EHR) that corresponds to the patient; receiving a sound file that includes information resulting from an examination of the patient, and translating the sound file into a document that comprises a clinical document architecture (CDA); parsing the document and identifying a plurality of data components based on a correspondence to a plurality of data fields of the EHR; and populating each of the plurality of data fields with each of the data components.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments is not intended to be exhaustive or to limit the systems and methods described to the precise form disclosed. While specific embodiments and examples are described herein for illustrative purposes, various equivalent modifications are possible within the scope of other systems and methods, as those skilled in the relevant art will recognize. The teachings provided herein can be applied to other processing systems and methods, not only for the systems and methods described above.

The elements and acts of the various embodiments described above can be combined to provide further embodiments. These and other changes can be made to the embodiments in light of the above detailed description.

In general, in the following claims, the terms used should not be construed to limit the embodiments described above to the specific embodiments disclosed in the specification and the claims, but should be construed to include all systems and methods that operate under the claims. Accordingly, the embodiments described above are not limited by the disclosure, but instead the scope is to be determined entirely by the claims.

While certain aspects of the embodiments described above are presented below in certain claim forms, the inventor contemplates the various aspects of the embodiments described above in any number of claim forms. Accordingly, the inventor reserves the right to add additional claims after filing the application to pursue such additional claim forms for other aspects of the embodiments described above.

APPENDIX
Health Level 7 (HL7) Clinical Document Architecture (CDA) Document Sample
(Deidentified)

```
<ClinicalDocument mm:major=“2” mm:minor=“2”
    xmlns:mm=“http://TEST.com/cdaExtensions” xmlns=“urn:hl7-org:v3”>
<component>
<bodyChoice>
<StructuredBody>
<component>
<section>
<title />
<code code=“0” codeSystem=“2.16.840.1.113883.3.21” codeSystemName=“MM-LOINC” />
<text>
<paragraph />
<paragraph>
<content mm:status=“normal”>Thank you for asking me to see Bill Jones in consultation.
    Enclosed please find a copy of my office note for your review.</content>
  </paragraph>
<paragraph />
<paragraph>
<content mm:status=“normal”>Should you have any questions, please do not hesitate to
    contact me.</content>
  </paragraph>
<paragraph />
  </text>
  </section>
  </component>
<component>
<section>
<title>Findings</title>
<code code=“10004” codeSystem=“2.16.840.1.113883.3.21” codeSystemName=“MM-
    LOINC” />
<text>
<paragraph>
<content mm:status=“normal”>Examination of the left and right hip reveals full range of
    motion of the hip in internal/external rotation, flexion and extension, abduction and
    adduction. There is no spasm or muscle pain. There is normal sensation over the hip
    area. The patient has no increased pain at the extremes of motion, especially internal
    rotation. There is normal muscle bulk around the hip girdle. Negative Trendelenburg
    sign. Examination of the left and right knee reveals full range of motion including
    flexion and extension. There is no ligamentous instability, no effusion, and no skin
    changes over the knee are noted. There is no pain on extension, no pain on flexion.
    The patella tracks normally. Examination of the left and right ankle reveals full
    range of motion in dorsiflexion/plantar flexion. There is normal subtalar motion. The
    patient has no swelling or effusion or skin changes over the ankle. Examination of the
    left and right foot reveals the patient walks without a limp and has no malalignment
    of the foot itself. Good motion of the hindfoot, subtalar joint, and forefoot. No skin
    changes over the foot. No point tender areas. No effusion. No ligamentous
    instability.</content>
  </paragraph>
<paragraph />
  </text>
  </section>
  </component>
<component>
<section>
<title>Indication</title>
<code code=“5191” codeSystem=“2.16.840.1.113883.3.21” codeSystemName=“MM-
    LOINC” />
<text>
<paragraph />
<paragraph>
<content>Test Note Here</content>
  </paragraph>
<paragraph />
  </text>
  </section>
  </component>
<component>
<section>
<title>Radiographs</title>
<code code=“5230” codeSystem=“2.16.840.1.113883.3.21” codeSystemName=“MM-
    LOINC” />
<text>
<paragraph />
<paragraph>
<content mm:status=“normal”>Otherwise bilateral upper extremity and bilateral lower
    extremity musculoskeletal exam normal to inspection, range of motion, strength, and
    stability</content>
  </paragraph>
<paragraph />
  </text>
  </section>
  </component>
  </StructuredBody>
  </bodyChoice>
  </component>
<effectiveTime value=“” />
<title />
<recordTarget>
<patientRole>
<patientPatient>
<name>
<given>Bill</given>
<family>Jones</family>
  </name>
<birthTime value=“19390623” />
  </patientPatient>
<id extension=“656565” />
  </patientRole>
  </recordTarget>
<author>
<assignedAuthor>
<assignedAuthorChoice>
<Person>
<name>
<given />
<family />
  </name>
  </Person>
  </assignedAuthorChoice>
  </assignedAuthor>
  </author>
<mm:log>
<mm:logEntry time=“30740” downloadTime=“253” pauseTime=“0” logLevel=“1”
    timeStamp=“9/3/2009 11:59:54” audioTime=“1” timeOfFirstEditEvent=“254”
    editorVersion=“4.1.2360.0” MT=“Production@MxSecure.com” MTID=“32”
    MTRole=“MxSecure.US.Editor - in training”
    timeZone=“+0700”>fsICAAAAAAAALMn9wH3ZgBGYEI23_DFAktYBnaJulfylWsC
    OnSxumSmlkfROXSR5AVWQg_ikq5N4SSsoSCInErMpETObEKidJRSR8EcJ5XAq
    qh1nyADc_ZkUDrJnTmILJvBhkkcldqVqQRpWSpFlHCVEfOE2KK6SESNAAAZA
    IXiBBAAA<mm:logEntry>
<mm:logEntry time=“487761” downloadTime=“252” pauseTime=“160703” logLevel=“1”
    timeStamp=“9/3/2009 12:10:33” audioTime=“1” timeOfFirstEditEvent=“252”
    editorVersion=“4.1.2360.0” MT=“Production@MxSecure.com” MTID=“32”
    MTRole=“MxSecure.US.Editor - in training”
    timeZone=“+0700”>fsICAAAAAAAAL0oIPhEFRxxxnN2ZmdX0CDyDBCL1RvY2xu
    ks4mBrlwoIVSw4Mv2Gc2dWn5tWWZQRdKqOFWQ_ZhSL6PmEFEBqBBSHKJC
    lqbdII6gGR1htCsdEx3v5Nu_e7ALswnP_evv_e8evZS1Rm9IJJFpyvOXe1nK_vRNC
    NtjRRvkpM9a30i64mi6avK1_5fA761o6u0us1HufdjBYSyfDIVnG1pQQnolkk
    xZBOyG2WQ4viAgJGgMcSXCtobemxvHHmjudym1moRMoWOAp_8cgUc_hxrguB
    ZNhIx2X1DR00TjAzMrgEK3z1re5yH4Rw47XuWHp7u5j6kjlO5DOO_cYSsJUgxhm
    DvBlPydQCh1lE1D5aW8qss7zQmD6SCS4oPGp6rugoEetpFZU671QPc3REEzJ
    KSMn8TIwncZE4PHEAbYv59Iu0Kn8S7qnNHJPlJWeRgY0eyb6wYLPBgFbl9JOHj
    1cK78112kosb4qw6tYqY1VNOU5gXBw11KDB3xEsZUO
    VQK8EDiAPpHC8UXABe6mQgnBeUVxfRpYBGdsWqxFk7pjMH3vBE4DuNCcSZs
    090zDorszIwlwKvIHyQPVvIwZI8jcw9cvcLC4ThzfFMZq 8WbtFGe2R4LPYj9mxQy
    cInlVeH2eh3D76Qr2zfRM6HuBeHXeIAHZnk6G
    b1ToqybBwEr9il2YGqPEWuvRvMYs
    4htzgxjyD1AwM8w9DgnjH2JAOPycm4Lrb_sDmRdfUoRZRG1vVhG7SoRfCNCd9a
    IjbK0YGhGfWkxGD91VhM2mQjUCNMFZspm4N4edj6mh3iwfiStxbBo8HESWCB
    e4RBw4aV qKDab22Mh 3eVr _wKYjkS6sAAAA</mm:logEntry>
<mm:logEntry time=“269935” downloadTime=“263” pauseTime=“203390” logLevel=“1”
    timeStamp=“9/3/2009 13:30:37” audioTime=“1” timeOfFirstEditEvent=“264”
    editorVersion=“4.1.2360.0” MT=“Production@MxSecure.com” MTID=“32”
    MTRole=“MxSecure.US.Editor - in training”
    timeZone=“+0700”>fsICAAAAAAAALMn9wH3ZgBGYEIOm_DFAktYBnaJulfylWs
    COnSxumSmlkfROXSR5AVWQagdkUNvBXSiFVSA5kYlJlYyZjQRcoJSKi1kzJTY
    Sy2TYgBumKSSyTwlkfBoaAcGODswfx4wA4McAkr4kGmLAAAA</mm:logEntry>
<mm:logEntry time=“286855” downloadTime=“259” pauseTime=“27608” logLevel=“1”
    timeStamp=“9/3/2009 13:36:31” audioTime=“1” timeOfFirstEditEvent=“260”
    editorVersion=“4.1.2360.0” MT=“Production@MxSecure.com” MTID=“32”
    MTRole=“MxSecure.US.Editor - in training”
    timeZone=“+0700”>fsICAAAAAAAALMn9wH3ZgBGYEIO0_DFAktYBnaJulfylWs
    COnSxumSmlkfROXSR5AVWQagZkUNvBXSiFVSA5kYlJlYyZjQRsYBSKingLJ_
    CQVNM9PGYMqCQSNcGcq5kayl4YO5ATBAQdJrOvgCAAAA</mm:logEntry>
  </mm:log>
<mm.customerADT>
<mm:propertyGroup name=“TranscriptionInfo”>
<mm:property key=“WorktypeName” value=“office_note” type=“string” />
<mm:property key=“WorktypeCode” value=“offnote_BETA PRACTICE” type=“string” />
<mm:property key=“TranscriptionID” value=“12383355” type=“string” />
<mm:property key=“FileType” value=“.DSS” type=“string” />
<mm:property key=“DateDictated” value=“08/31/2009” type=“string” />
<mm:property key=“Uploaded” value=“09-02-2009 12:59” type=“string” />
<mm:property key=“DateTyped” value=“09/03/2009” type=“string” />
<mm:property key=“AutoFax” value=“James Schulte MD:4809994885|” type=“string” />
<mm:property key=“ReferringProviderName” value=“Gene Baskin PA|Gregg Heinz
    M.D.|Cesar J. Brooks M.D.|Winfred Guardia MD|Will Lukens M.D.|Todd Delphi
    M.D.|David Rusty MD|” type=“string” />
<mm:property key=“ReferringProviderAddress” value=“Lynchburg, VA
    24501|Lynchburg, VA 24503|Roanoke, VA 24014|Lynchburg, VA 24501|Unit 55,
    Forest, VA 24551|9999 Dragle Road, Moneta, VA 24121|Lynchburg, VA 24501|”
    type=“string” />
<mm:property key=“CCLabel10” value=“cc:” type=“string” />
<mm:property key=“CCName10” value=“Chester Smith MD-10” type=“string” />
<mm:property key=“CCLabel1” value=“cc,lc:” type=“string” />
<mm:property key=“CCName1” value=“James Schulte MD-1” type=“string” />
<mm:property key=“CCLabel2” value=“cc:” type=“string” />
<mm:property key=“CCName2” value=“Gabriel Baldwin MD-2” type=“string” />
<mm:property key=“CCLabel3” value=“cc:” type=“string” />
<mm:property key=“CCName3” value=“Erica Knoly MD-3” type=“string” />
<mm:property key=“CCLabel4” value=“cc:” type=“string” />
<mm:property key=“CCName4” value=“Thomas Thomes MD-4” type=“string” />
<mm:property key=“CCLabel5” value=“cc:” type=“string” />
<mm:property key=“CCName5” value=“Josie Jenkins MD-5” type=“string” />
<mm:property key=“CCLabel6” value=“cc:” type=“string” />
<mm:property key=“CCName6” value=“Adora Bell MD-6” type=“string” />
<mm:property key=“CCLabel7” value=“cc:” type=“string” />
<mm:property key=“CCName7” value=“John Nagle MD-7” type=“string” />
<mm:property key=“CCLabel8” value=“cc:” type=“string” />
<mm:property key=“CCName8” value=“Dawn Franklin MD-8” type=“string” />
<mm:property key=“CCLabel9” value=“cc:” type=“string” />
<mm:property key=“CCName9” value=“Donald Beck MD-9” type=“string” />
  </mm:propertyGroup>
<mm:propertyGroup name=“TranscriberInfo”>
<mm:property key=“MTID” value=“32” type=“string” />
<mm:property key=“MTName” value=“Production@MxSecure.com” type=“string” />
<mm:property key=“OrgID” value=“62” type=“string” />
<mm:property key=“MT_Initials” value=“JTN” type=“string” />
  </mm:propertyGroup>
<mm:propertyGroup name=“PracticeInfo”>
<mm:property key=“PracticeName” value=“Orthopaedic Center of Central Virginia”
  type=“string” />
<mm:property key=“PracticeID” value=“BETA PRACTICE” type=“string” />
<mm:property key=“PracticeKey” value=“279952” type=“string” />
  </mm:propertyGroup>
<mm:propertyGroup name=“ProviderInfo”>
<mm:property key=“ProviderKey” value=“299335” type=“string” />
<mm:property key=“ProviderName” value=“James Cash” type=“string” />
<mm:property key=“ProviderFormattedName” value=“James Cash, M.D.” type=”string”
  />
<mm:property key=“ProviderInitals” value=“JC” type=“string” />
<mm:property key=“ProviderUser1” value=“BETA PRACTICE|%” type=“string” />
<mm:property key=“ProviderUser2” value=“” type=“string” />
<mm:property key=“ProviderUser3” value=“JC” type=“string” />
    </mm:propertyGroup>
<mm:propertyGroup name=“PatientInfo”>
<mm:property key=“PID” value=“000000656565” type=“string” />
<mm:property key=“PatientLastName” value=“Bill” type=“string” />
<mm:property key=“PatientFirstName” value=“Jones” type=“string” />
<mm:property key=“MRN” value=“656565” type=“string” />
<mm:property key=“User1” value=“” type=“string” />
<mm:property key=“User2” value=“” type=“string” />
<mm:property key=“User3” value=“” type=“string” />
<mm:property key=“User4” value=“” type=“string” />
<mm:property key=“User5” value=“” type=“string” />
<mm:property key=“ApptDate-Long Format” value=“September 3, 2009” type=“string” />
<mm:property key=“ApptDate-Short Format” value=“09/03/2009” type=“string” />
<mm:property key=“DOS” value=“” type=“string” />
  </mm:propertyGroup>
  </mm:customerADT>
  </ClinicalDocument>
```

What is claimed is:

1. A system comprising:
a platform comprising a processor coupled to a medical application;
at least one input device coupled to the processor, wherein the at least one input device receives patient information of a patient via an electronic form and receives vital signs of the patient;
wherein the medical application integrates the patient information and the vital signs into an electronic health record (EHR) that corresponds to the patient;
wherein the medical application receives a sound file that includes information resulting from an examination of the patient, and translates the sound file into a document that comprises a clinical document architecture (CDA);
wherein the medical application parses the document and identifies a plurality of data components based on a correspondence to a plurality of data fields of the EHR; and
wherein the medical application populates each of the plurality of data fields with each of the data components.

2. A method running on a processor of a platform, the method comprising:
receiving patient information from a patient via an electronic form;
receiving vital signs of the patient;
integrating the patient information and the vital signs into an electronic health record (EHR) that corresponds to the patient;
receiving a sound file that includes information resulting from an examination of the patient, and translating the sound file into a document that comprises a clinical document architecture (CDA);
parsing the document and identifying a plurality of data components based on a correspondence to a plurality of data fields of the EHR; and
populating each of the plurality of data fields with each of the data components.
